(19) United States
(12) Patent Application Publication
(10) Pub. No.: US 2024/0273955 A1
(43) Pub. Date: Aug. 15, 2024

(54) SYSTEM FOR DETERMINING ABNORMALITIES IN EXTERNAL RECOGNITION, VEHICLE-MOUNTED DEVICE, AND METHOD FOR DETERMINING ABNORMALITIES IN EXTERNAL RECOGNITION

(71) Applicant: Hitachi Astemo, Ltd., Hitachinaka-shi, Ibaraki (JP)

(72) Inventors: Yusuke NOMA, Hitachinaka-shi, Ibaraki (JP); Shoji MURAMATSU, Hitachinaka-shi, Ibaraki (JP)

(73) Assignee: Hitachi Astemo, Ltd., Hitachinaka-shi, Ibaraki (JP)

(21) Appl. No.: 18/561,641

(22) PCT Filed: Feb. 2, 2022
(86) PCT No.: PCT/JP2022/004089

§ 371 Date: Nov. 16, 2023

(30) Foreign Application Priority Data
May 21, 2021 (JP) 2021-086152

(51) Int. Cl. G07C 5/08; G01C 21/30; H04W 4/40

(52) U.S. Cl. CPC G07C 5/0808; G01C 21/30; H04W 4/40

(57) ABSTRACT

Provided is an external recognition abnormality determination system capable of determining abnormality of a recognition result of an external recognition sensor even in a vehicle that does not have an alternative available external recognition sensor. An external recognition abnormality determination system determines abnormality of an operation of an external recognition sensor of a vehicle. The vehicle transmits, to a cloud server, type information and a recognition result of the external recognition sensor, and a self-position estimation result that is an estimation result of a self-position of the vehicle. The cloud server accumulates cloud data in which type information and recognition results of the external recognition sensors which are received from a plurality of vehicles and the self-position estimation result are associated with map information, and updates the cloud data. The cloud server determines an abnormality in operation of the external recognition sensor based on the recognition result and the cloud data.

### TECHNICAL FIELD

The present invention relates to an external recognition abnormality determination system, a vehicle mounted device, and a method for determining abnormalities in external recognition for determining a recognition result by a vehicle mounted external recognition sensor on a cloud server.

### BACKGROUND ART

As a vehicle control system using a recognition result of a vehicle mounted external recognition sensor for vehicle control, there are known driving support systems such as an adaptive cruise control (ACC) that follows and travels so that an inter-vehicle distance from a preceding vehicle becomes substantially constant, an advanced emergency braking system (AEBS) that activates emergency braking when there is a possibility of collision, a lane keeping assist system (LKAS) that assists steering so as to maintain a traveling lane, and an automated driving system.

In addition, as a conventional automated driving vehicle, there is known a vehicle in which an external recognition sensor that can be used as a substitute when a certain external recognition sensor fails is prepared to increase redundancy. For example, in the abstract of PTL 1, “Systems and methods are provided for handling sensor faults in an automated driving vehicle (ADV) navigating in a world coordinate system that is an absolute coordinate system.” is described in the Problem field, and “Even if a sensor fault occurs in the ADV, if at least one camera is operating normally, the sensor fault handling system converts the ADV from navigating in world coordinates to navigating in local coordinates, where the ADV safely drives in dependence on obstacle detection and lane marking detection by the camera until a person leaves or the ADV is parked along a roadside in the local coordinates.” is described in the Solution field.

As described above, in the automated driving vehicle of PTL 1, when one external recognition sensor fails, the automated driving is continued until the vehicle is parked beside the road using the normal camera (another external recognition sensor) that substitutes the role of the failed sensor.

### CITATION LIST

### Patent Literature

PTL 1: JP 2019-219396 A

### SUMMARY OF INVENTION

### Technical Problem

With the configuration in which an alternative external recognition sensor is prepared and redundancy is provided as in PTL 1, a sensor failure can be determined by comparing the outputs of the respective sensors. However, not only the component cost increases due to the addition of sensors, but also the system cost increases due to various design costs for making sensors redundant or the adoption of a high-performance electronic control unit (ECU) that can cope with the addition of sensors.

Therefore, an object of the present invention is to provide an external recognition abnormality determination system, a vehicle mounted device, and a method for determining abnormalities in external recognition capable of determining abnormality of a recognition result of an external recognition sensor even in a vehicle that does not have an alternative available external recognition sensor.

### Solution to Problem

An external recognition abnormality determination system of the present invention to solve the above problem is a system that determines abnormality of an operation of an external recognition sensor of a vehicle. The vehicle transmits, to a cloud server, type information and a recognition result of the external recognition sensor, and a self-position estimation result that is an estimation result of a self-position of the vehicle. The cloud server accumulates cloud data in which type information and recognition results of the external recognition sensors which are received from a plurality of vehicles and the self-position estimation result are associated with map information, and updates the cloud data. The cloud server determines an abnormality in operation of the external recognition sensor based on the recognition result and the cloud data.

### Advantageous Effects of Invention

According to the present invention, it is possible to determine the abnormality of the recognition result of the external recognition sensor even in a vehicle that does not have an alternative available external recognition sensor. As a result, it is possible to suppress an increase in manufacturing cost, design cost, and the like due to redundancy of the external recognition sensor.

### BRIEF DESCRIPTION OF DRAWINGS

FIG. 1 is a functional block diagram of an external recognition abnormality determination system according to a first embodiment.

FIG. 2 is a plan view illustrating an example of a travel environment of an own vehicle according to the first embodiment.

FIG. 3 is an exemplary diagram of transmission data and reception data of the vehicle mounted device according to the first embodiment.

FIG. 4 is a processing flowchart of a control possibility determination unit according to the first embodiment.

FIG. 5 is a processing flowchart of a recognition result determination unit according to the first embodiment.

FIG. 6 is a plan view illustrating another example of the travel environment of the own vehicle according to the first embodiment.

FIG. 7 is a processing flowchart of a temporary storage unit and an update determination unit according to the first embodiment.

FIG. 8 is a functional block diagram of an external recognition abnormality determination system according to a second embodiment.

FIG. 9 is a plan view illustrating an example of travel environments of an own vehicle and another vehicle according to the second embodiment.

FIG. 10 is a processing flowchart of a position information determination unit according to the second embodiment.

FIG. 11 is an exemplary diagram of transmission data and reception data of the vehicle mounted device of the second embodiment.

FIG. 12 is a plan view illustrating an example of travel environments of the own vehicle according to a third embodiment.

FIG. 13 is a processing flowchart of a cloud server according to the third embodiment.

FIG. 14 is an exemplary diagram of transmission data and reception data of the vehicle mounted device according to the third embodiment.

### DESCRIPTION OF EMBODIMENTS

Hereinafter, an embodiment of an external recognition abnormality determination system according to the present invention will be described with reference to the drawings.

### First Embodiment

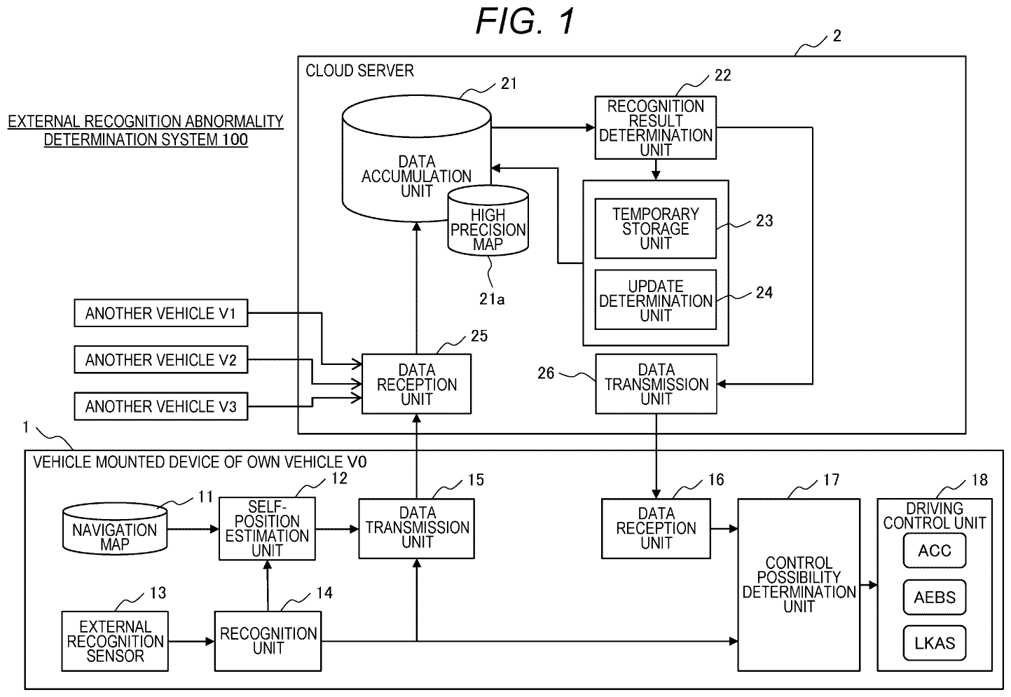

First, an external recognition abnormality determination system 100 according to a first embodiment of the present invention will be described with reference to FIGS. 1 to 7.

FIG. 1 is a functional block diagram schematically illustrating an overall configuration of the external recognition abnormality determination system 100 according to the present embodiment. The external recognition abnormality determination system 100 is a system in which the vehicle mounted device 1 of an own vehicle V0 and a cloud server 2 are wirelessly connected. Note that the cloud server 2 is a server capable of simultaneously communicating with a large number of vehicles, and FIG. 1 illustrates a state in which the cloud server 2 is wirelessly connected to the vehicle mounted devices 1 of the other vehicles V1, V2, and V3.

As illustrated herein, the vehicle mounted device 1 of the present embodiment includes a navigation map 11, a self-position estimation unit 12, an external recognition sensor 13, a recognition unit 14, a data transmission unit 15, a data reception unit 16, a control possibility determination unit 17, and a driving control unit 18. The cloud server 2 of the present embodiment includes a data accumulation unit 21, a recognition result determination unit 22, a temporary storage unit 23, an update determination unit 24, a data reception unit 25, and a data transmission unit 26. Further, the details will be described below.

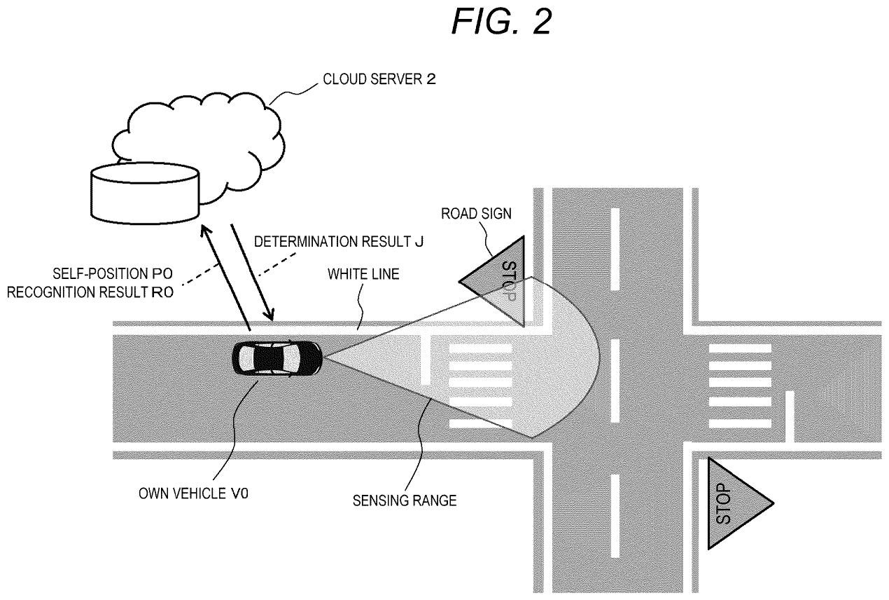

FIG. 2 is a plan view illustrating an example of a travel environment of the own vehicle V0. When traveling in this environment, the vehicle mounted device 1 of the own vehicle V0 detects a recognition result R0 of the target (white line, road marking, road sign, etc.) within the sensing range of the external recognition sensor 13. In addition, the vehicle mounted device 1 of the own vehicle V0 corrects position information obtained from a global navigation satellite system (GNSS) based on the recognition result R0 of the external recognition sensor 13, thereby estimating a more accurate self-position P0. Then, the vehicle mounted device 1 transmits the self-position P0 and the recognition result R0 to the cloud server 2.

On the other hand, the cloud server 2 compares the recognition result R0 received from the own vehicle V0 with a recognition result R received from a vehicle V traveling in the same place in the past, determines whether the recognition result R0 is normal or abnormal, and transmits the determination result J to the vehicle mounted device 1 of the own vehicle V0.

Thereafter, the vehicle mounted device 1 starts, continues, or stops the driving assistance control and the automated driving control according to the determination result J received from the cloud server 2. Hereinafter, details of the vehicle mounted device 1 and the cloud server 2 will be sequentially described.

### <Vehicle Mounted Device 1>

First, the vehicle mounted device 1 will be described with reference to FIGS. 1, 3, and 4. As illustrated in FIG. 1, the vehicle mounted device 1 includes a navigation map 11, a self-position estimation unit 12, an external recognition sensor 13, a recognition unit 14, a data transmission unit 15, a data reception unit 16, a control possibility determination unit 17, and a driving control unit 18.

The navigation map 11 is, for example, a road map having precision of about several meters provided in a general car navigation system, and is a low precision map without lane number information, white line information, or the like. On the other hand, a high precision map 21a to be described later is, for example, a road map having precision of about several cm, and is a high precision map having lane number information, white line information, and the like.

The self-position estimation unit 12 estimates an absolute position (self-position P0) of the own vehicle V0 on the navigation map 11. Note that, in the self-position estimation by the self-position estimation unit 12, in addition to the peripheral information obtained from the recognition result R0 of the external recognition sensor 13, the steering angle and the vehicle speed of the own vehicle V0, and the position information obtained from the GNSS are also referred to.

The external recognition sensor 13 is, for example, a radar, a LIDAR, a stereo camera, a mono camera, or the like. Although the own vehicle V0 includes the plurality of external recognition sensors 13, it is assumed that another external recognition sensor having an equivalent sensing range is not prepared for each external recognition sensor, and the redundancy is not enhanced. Note that the radar is a sensor that emits a radio wave toward a three-dimensional object and measures a reflected wave thereof to measure a distance and a direction to the three-dimensional object. The LIDAR is a sensor that emits laser light and measures the distance and direction to the three-dimensional object by measuring the light reflected from the three-dimensional object again. The stereo camera is a sensor capable of recording information in a depth direction by simultaneously photographing a three-dimensional object from a plurality of different directions. The mono camera is a sensor that does not have a depth direction but can record a distance of a three-dimensional object and peripheral information.

The recognition unit 14 recognizes three-dimensional object information such as a vehicle, a pedestrian, a road sign, a pylon, and a construction signboard, lane information, white line information such as a crosswalk and a stop line, and a road marking around the own vehicle V0 based on the output of the external recognition sensor 13, and outputs the information as a recognition result R0.

The data transmission unit 15 transmits the self-position P0 estimated by the self-position estimation unit 12 and transmission data based on the recognition result R0 recognized by the recognition unit 14 to the cloud server 2 using wireless communication.

In addition, the data reception unit 16 receives data from the cloud server 2 using wireless communication.

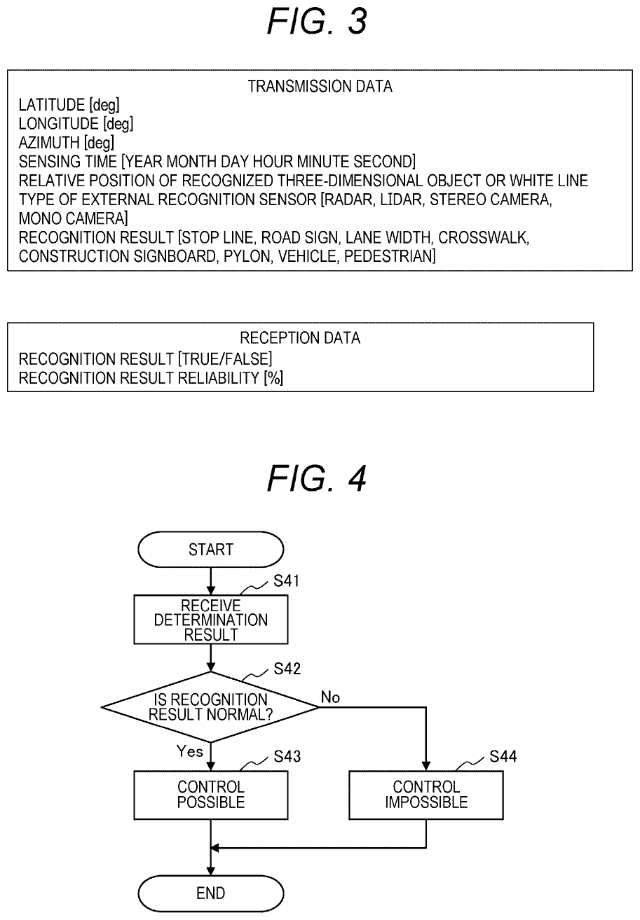

Here, an example of transmission data transmitted from the vehicle mounted device 1 to the cloud server 2 and reception data received from the cloud server 2 by the vehicle mounted device 1 is illustrated in FIG. 3. As illustrated herein, the transmission data is the latitude, longitude, and azimuth of the own vehicle V0 estimated by the self-position estimation unit 12, the sensing time of the recognition result R0, the relative position of the recognized three-dimensional object or white line, the type of the external recognition sensor used for sensing, and the recognition result of the surrounding three-dimensional object or sign. On the other hand, the reception data is the correctness and the reliability of the recognition result transmitted to the cloud server 2 as the transmission data.

The control possibility determination unit 17 determines possibility of driving assistance control or the like based on data received from the cloud server 2.

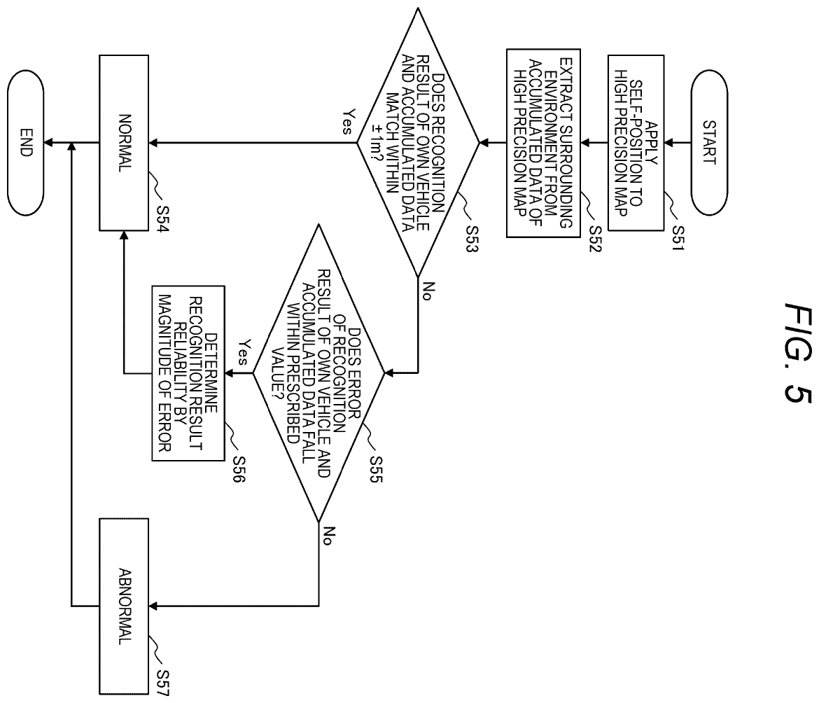

FIG. 4 is an example of a processing flowchart of the control possibility determination unit 17. First, in step S41, the control possibility determination unit 17 receives the determination result J of the cloud server 2. Next, in step S42, the control possibility determination unit 17 determines whether the received determination result J indicates whether the recognition result is normal [TRUE] or abnormal [FALSE]. Then, if it is normal, the control possibility determination unit 17 outputs a vehicle control possible command based on the recognition result R0 to the driving control unit 18 (step S43). On the other hand, if abnormal, the control possibility determination unit 17 outputs a control impossible command to the driving control unit 18 (step S44).

The driving control unit 18 starts, continues, or stops driving assistance control such as ACC, AEBS, and LKAS and automated driving based on the recognition result R0 according to a command from the control possibility determination unit 17. Specifically, the driving control unit 18 is an ECU that controls a steering system, a driving system, and a braking system of the own vehicle V0.

### <Cloud Server 2>

Next, the cloud server 2 will be described with reference to FIGS. 1 and 5 to 7. As illustrated in FIG. 1, the cloud server 2 includes a data accumulation unit 21, a recognition result determination unit 22, a temporary storage unit 23, an update determination unit 24, a data reception unit 25, and a data transmission unit 26.

The data accumulation unit 21 accumulates the transmission data of the vehicle mounted device 1 received by the data reception unit 25 for a certain period. The period during which the data accumulation unit 21 accumulates the transmission data may be several months or several years. In the data accumulation unit 21, the position information, the type of the external recognition sensor, and the recognition result transmitted from the plurality of vehicles are accumulated as cloud data in association with the information of the high precision map 21a. The accumulated data is used to accumulate the tendency of the recognition result R at the same position by the plurality of vehicles V.

The recognition result determination unit 22 determines whether the recognition result R0 included in the transmission data from the own vehicle V0 is normal in light of the accumulated data in the data accumulation unit 21.

FIG. 5 is an example of a processing flowchart of the recognition result determination unit 22. First, in step S51, the recognition result determination unit 22 applies the self-position P0 of the own vehicle V0 to the high precision map 21a. Next, in step S52, the recognition result determination unit 22 extracts the surrounding environment at the self-position P0 from the accumulated data of the high precision map 21a. In step S53, the recognition result determination unit 22 compares the three-dimensional object information and the like indicated by the recognition result R0 of the own vehicle V0 with the three-dimensional object information and the like extracted from the high precision map 21a, and determines whether the positions of both the three-dimensional objects, the white line, the road marking, and the like match within ±1 m. Then, if they match, the process proceeds to step S54, and if they do not match, the process proceeds to step S55.

In step S54, the recognition result determination unit 22 determines that the recognition result R0 of the own vehicle V0 is normal [TRUE].

On the other hand, in step S55, the recognition result determination unit 22 determines whether an error in the positions of both the three-dimensional objects, the white line, the road marking, and the like falls within a prescribed value (for example, ±3 m). Then, the process proceeds to step S56 when it is within the prescribed value, and the process proceeds to step S57 when it is not within the prescribed value.

In step S56, the recognition result determination unit 22 determines a lower recognition result reliability [%] as the error is closer to the prescribed value (as the error is larger), and determines a higher recognition result reliability [%] as the error is closer to +1 m (as the error is smaller). Thereafter, the process proceeds to step S54, where the recognition result determination unit 22 determines that the state is normal [TRUE], and then terminates the processing.

On the other hand, in step S57, after determining as abnormal [FALSE], the recognition result determination unit 22 ends the processing. Note that, in a case where there is no limitation of the prescribed value for determining the difference in position among the three-dimensional object, the white line, the road marking, and the like, the recognition result reliability in step S56 may not be determined.

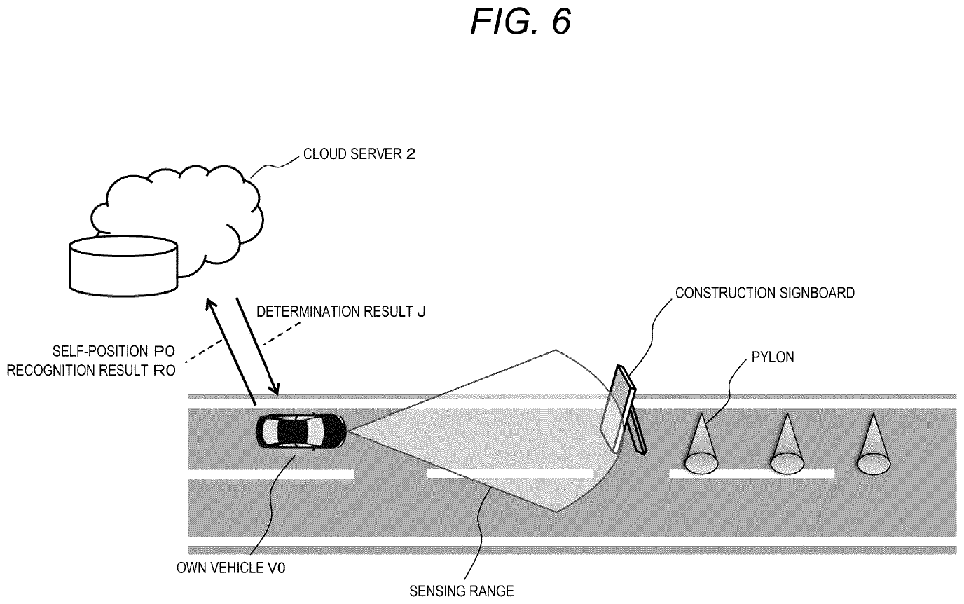

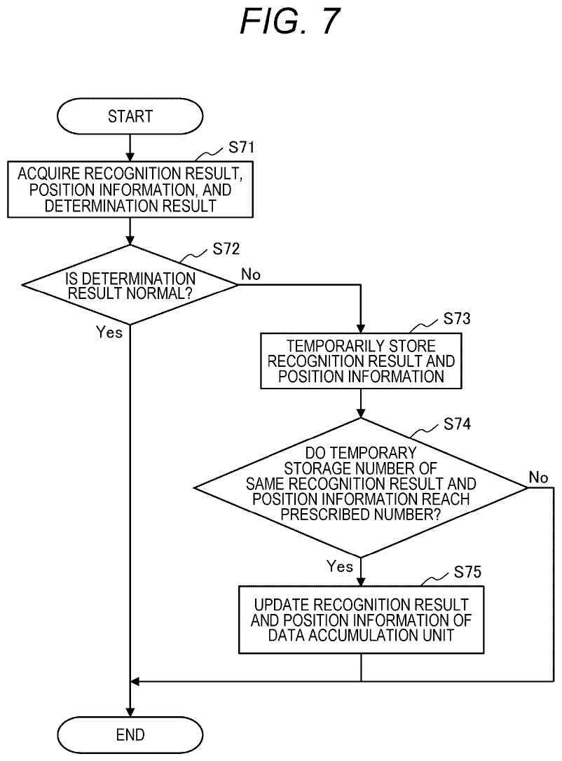

Next, the temporary storage unit 23 and the update determination unit 24 will be described with reference to FIGS. 6 and 7. FIG. 6 illustrates a situation in which the own vehicle V0 recognizes a three-dimensional object (construction signboard, Pylon) at the site of the emergency construction. FIG. 7 is an example of a processing flowchart of the temporary storage unit 23 and the update determination unit 24.

In a case where the site of the emergency construction is not registered in the high precision map 21a of the cloud server 2, according to the processing flowchart of FIG. 5, the recognition result determination unit 22 determines that the recognition result R0 (construction signboard, Pylon) received from the own vehicle V0 of FIG. 6 is abnormal. However, since there is a possibility that a three-dimensional object not included in the high precision map 21a is additionally installed, the high precision map 21a can be updated in a timely manner using the temporary storage unit 23 and the update determination unit 24.

Therefore, first, in step S71 of FIG. 7, the temporary storage unit 23 acquires the self-position P0 from the own vehicle V0, the recognition result R0, and the determination result J of the recognition result determination unit 22. Next, in step S72, the temporary storage unit 23 confirms whether the determination result J is normal [TRUE]. Then, if it is normal, the process is ended, and if it is abnormal [FALSE], the process proceeds to step S73. In step S73, the temporary storage unit 23 temporarily stores the self-position P0 from the own vehicle V0 and the recognition result R0.

Next, in step S74, as a result of temporarily storing the self-position P0 and the recognition result R0 in step S73, the update determination unit 24 determines whether the temporary storage number of the combination of the self-information P and the recognition result P that is the same as or approximate to the combination of the self-position P0 and the recognition result R0 has reached a prescribed number. Then, if the prescribed number has not been reached, the process ends, and if the prescribed number has been reached, the process proceeds to step S75.

In a case recognition result where the same (construction signboard or pylons in FIG. 6) at the same position is repeatedly transmitted from a large number of vehicles, it is considered that there is a change in the surrounding environment. Therefore, in step S75, the update determination unit 24 updates the accumulated data of the high precision map 21a by associating the recognition result R0 of the own vehicle V0 with the self-position P0. In FIG. 6, the site of the emergency construction is exemplified as an example of the situation in which the accumulated data in the data accumulation unit 21 is updated, but the accumulated data may be updated under various situations such as an accident site, addition, change, and removal of a road sign, a white line, and a road marking.

The data transmission unit 26 transmits the data output by the recognition result determination unit 22 to the vehicle mounted device 1.

According to the external recognition abnormality determination system 100 of the present embodiment described above, it is possible to determine the abnormality of the recognition result of the external recognition sensor in cooperation with the cloud server even for a vehicle that does not have an alternative available external recognition sensor. As a result, it is possible to suppress an increase in manufacturing cost, design cost, and the like due to redundancy of the external recognition sensor.

### Second Embodiment

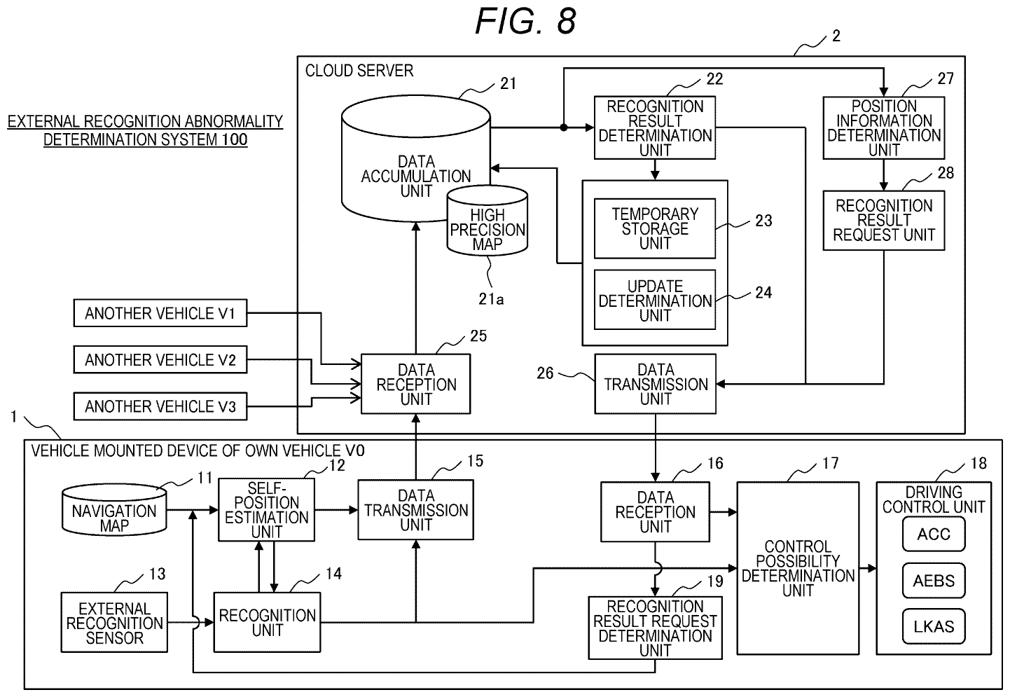

Next, an external recognition abnormality determination system 100 according to a second embodiment of the present invention will be described with reference to FIGS. 8 to 11. Description of some points in common with the first embodiment will be omitted.

In the first embodiment, the timing of transmitting the recognition result R from the vehicle mounted device 1 to the cloud server 2 is not particularly controlled. That is, the cloud server 2 of the first embodiment accepts the recognition result R detected by a large number of vehicles V at discrete places as it is, and there is no idea of intensively collecting the recognition result R for a certain specific area to actively improve the accuracy of the cloud data of the specific area and improve the accuracy of the abnormality determination of the external recognition sensor 13.

On the other hand, in the present embodiment, by requesting transmission of the recognition result R from the cloud server 2 to the vehicle mounted device 1 of the vehicle V traveling in the specific area, the accumulation amount of the recognition result R in the specific area can be actively increased, and the accuracy of the cloud data of the specific area can be enhanced.

FIG. 8 is a functional block of the external recognition abnormality determination system 100 of the present embodiment, and a recognition result request determination unit 19 is added on the vehicle mounted device 1 side as compared with FIG. 1 which is a functional block of the external recognition abnormality determination system 100 of the first embodiment. Further, a position information determination unit 27 and a recognition result request unit 28 are added to the cloud server 2.

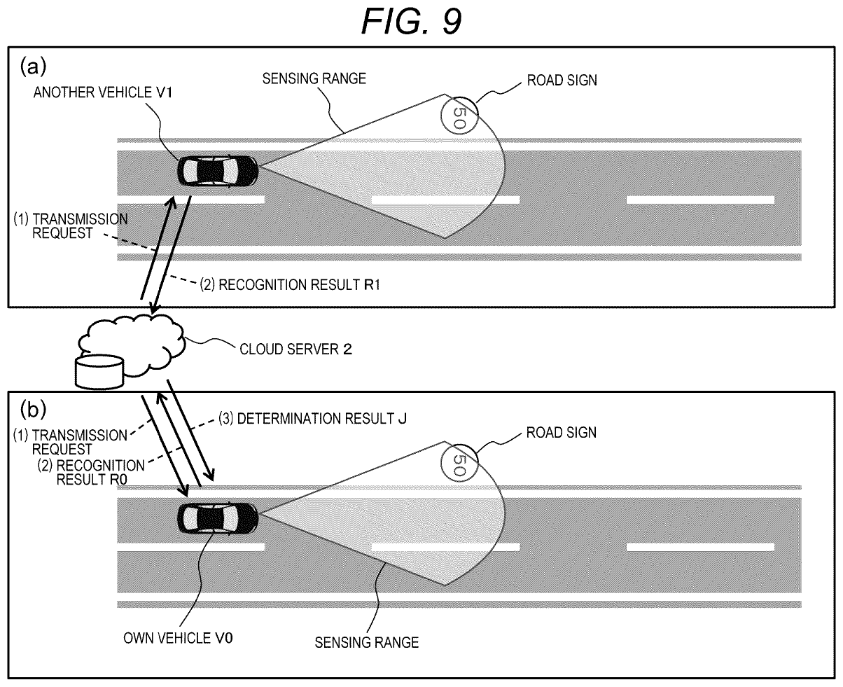

FIG. 9 is a plan view illustrating an example of a travel environment of another vehicle V1 and the own vehicle V0 of the present embodiment. FIG. 9(a) illustrates an outline of data transmission and reception between the other vehicle V1 and the cloud server 2 before the accumulation amount of the recognition result R reaches a predetermined number in the specific area determined as the focused collection area of the recognition result R by the cloud server 2. Here, since it is considered that the accumulation amount of the recognition result R of the cloud server 2 is not sufficient and the reliability of the high precision map 21a is low, the cloud server 2 does not perform abnormality determination on the external recognition sensor 13 of the other vehicle V1 even when receiving the recognition result R1 from the other vehicle V1.

On the other hand, FIG. 9(b) illustrates an outline of data transmission and reception between the own vehicle V0 and the cloud server 2 after the accumulation amount of the recognition result R in the specific area reaches a predetermined number. Here, since it is considered that the accumulation amount of the recognition result R of the cloud server 2 is sufficient and the reliability of the high precision map 21a is high, the cloud server 2 receives a recognition result R1 from the own vehicle V0 and then returns the determination result J of the external recognition sensor 13 of the own vehicle V0.

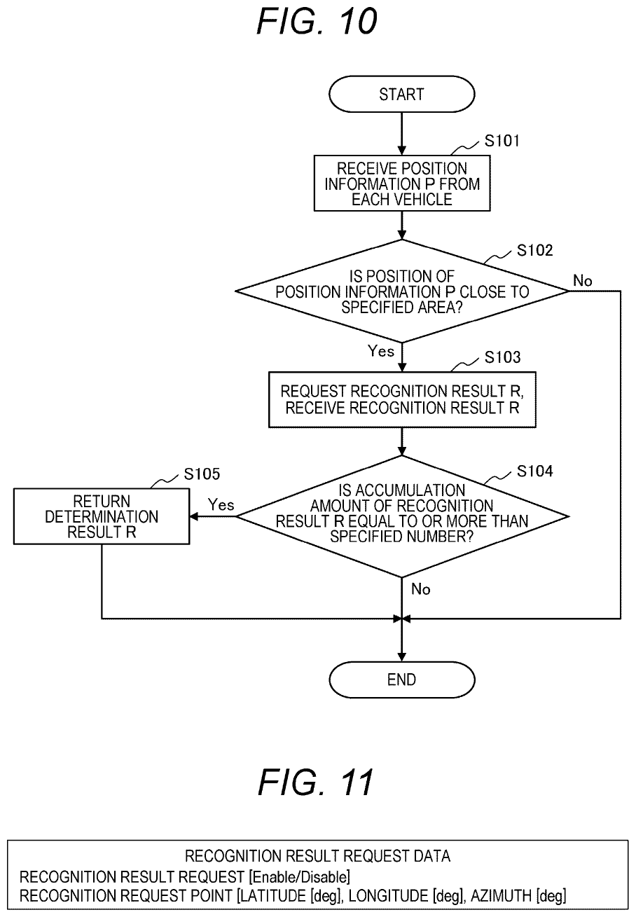

FIG. 10 is an example of a processing flowchart for realizing the behavior illustrated in FIG. 9. First, in step S101, the data reception unit 25 of the cloud server 2 receives position information P from the vehicle mounted device 1 of each vehicle. Next, in step S102, a position information determination unit 27 of the cloud server 2 determines whether the position indicated by the received position information P is approaching the specific area. Then, in a case where the user is approaching the specific area, the process proceeds to step S103, and otherwise, the process ends.

In step S103, the recognition result request unit 28 requests the vehicle mounted device 1 to transmit the recognition result R via the data transmission unit 26. Note that, since a round trip processing time of transmission and reception between the vehicle mounted device 1 and the cloud server 2 is required, for example, it is conceivable to obtain from the vehicle speed, the distance, and the arrival time to the point, such as transmitting a recognition result request 50 m before the specific area on the assumption that the vehicle V is traveling at 50 km/h with respect to the vehicle V traveling on a general road, and outputting a recognition result request 100 m before the specific area on the assumption that the vehicle V is traveling at 80 km/h with respect to the vehicle V traveling on a highway.

In addition, in this step, the recognition result request determination unit 19 of the vehicle mounted device 1 outputs the position information of the point where the transmission of the recognition result R is requested to the self-position estimation unit 12 in accordance with the request from the recognition result request unit 28. When reaching the designated point, the self-position estimation unit 12 requests the recognition unit 14 to output the recognition result R. As a result, the data reception unit 25 of the cloud server 2 can receive the recognition result R at the point designated by itself.

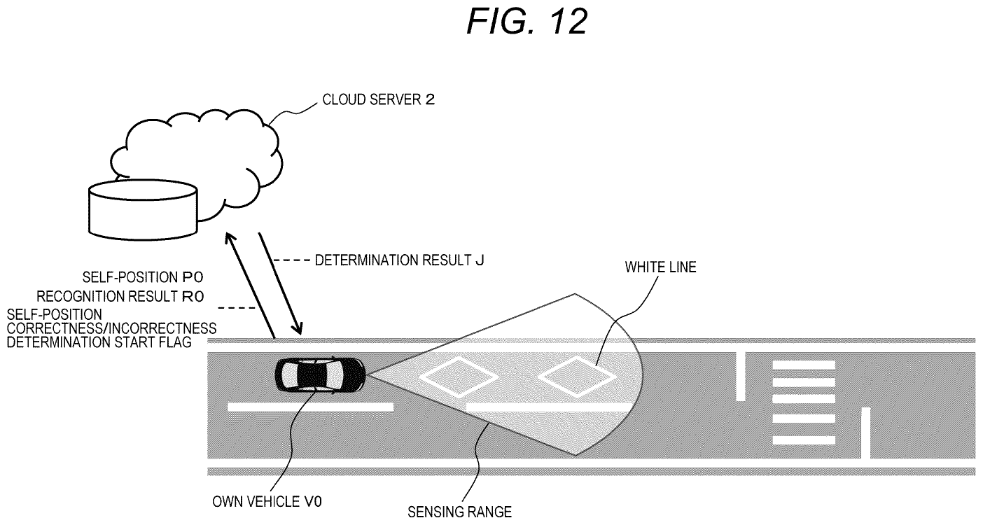

Here, the content of the recognition result request data transmitted from the cloud server 2 to the vehicle mounted device 1 is illustrated in FIG. 11. As illustrated here, the recognition result request includes information indicating validity/invalidity of the recognition result request from the cloud server 2 and data indicating a recognition request point, and the cloud server 2 can notify the vehicle V traveling nearby of a desired point where the recognition result R is to be intensively collected.

In step S104, the recognition result determination unit 22 of the cloud server 2 determines whether the accumulation amount of the recognition result R at the point is equal to or more than a predetermined number. Then, if the accumulation amount is equal to or larger than the predetermined number, the process proceeds to step S105, and if not, the process ends.

In step S105, the recognition result determination unit 22 refers to the high precision map 21a reflecting a sufficient amount of the recognition result R, and determines the appropriateness/inappropriateness of the recognition result R currently received from the vehicle V. By doing so, in the present embodiment, the determination result J is returned to the vehicle V only in a case where the determination result J with high reliability can be generated, and before that, the user concentrates on the collection of the recognition result R.

### Third Embodiment

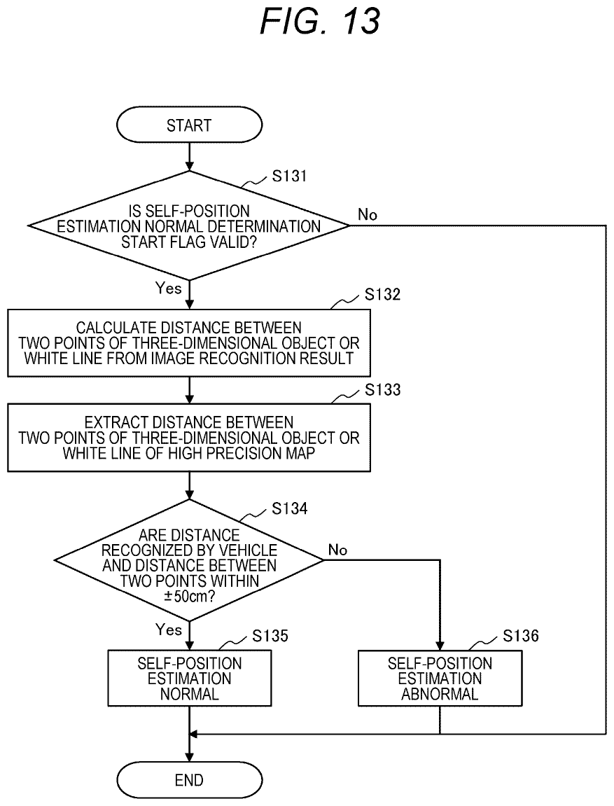

Next, an external recognition abnormality determination system 100 according to a third embodiment of the present invention will be described with reference to FIGS. 12 to 14. Description of some points in common with the above-described embodiment will be omitted.

In the first embodiment and the second embodiment, the recognition result R is determined to be abnormal on the assumption that a self-position P estimated by the self-position estimation unit 12 is correct, but in the present embodiment, the abnormality of the self-position P estimated by the self-position estimation unit 12 can also be determined.

FIG. 12 is a plan view illustrating an example of a travel environment of the own vehicle V0, and is an example of an environment for determining an abnormality of the self-position P in addition to the abnormality determination of the recognition result R. In the present embodiment, in order to determine the abnormality of the estimated self-position P0, the vehicle mounted device 1 of the own vehicle V0 transmits, to the cloud server 2, a self-position correctness/incorrectness determination start flag in addition to the recognition result R of detecting a crosswalk, an attention sign with a crosswalk, or the like at a short interval (for example, at an interval of one second), and the estimated self-position P0.

FIG. 13 is an example of a flowchart illustrating the operation of the cloud server 2 of the present embodiment. First, in step S131, the recognition result determination unit 22 of the cloud server 2 determines the self-position correctness/incorrectness determination start flag from the vehicle mounted device 1. If the self-position correctness/incorrectness determination start flag is invalid [Disable], only the determination result J for the recognition result R is transmitted to the vehicle mounted device 1, and the process ends.

On the other hand, when the self-position correctness/incorrectness determination start flag is valid [Enable], the determination result J for the estimation result of the self-position P is also returned to the vehicle mounted device 1 in addition to the determination result J for the recognition result R by the processing of steps S132 to S136.

Therefore, in step S132, the recognition result determination unit 22 calculates the distance between two three-dimensional objects or the white line recognized at the short interval received from the vehicle mounted device 1. Then, in step S133, the recognition result determination unit 22 refers to the high precision map 21a and extracts the distance between two points in the real environment of the three-dimensional object or the white line.

In step S134, the recognition result determination unit 22 compares the distance between two points calculated in step S132 with the distance between two points extracted in step S133, and determines s whether the difference therebetween is a predetermined error (for example, within ±50 cm). Then, if the error is within ±50 cm, the self-position estimation normal (step S135) is transmitted to the vehicle mounted device 1, and if the error exceeds ±50 cm, the self-position estimation abnormal is transmitted (step S136).

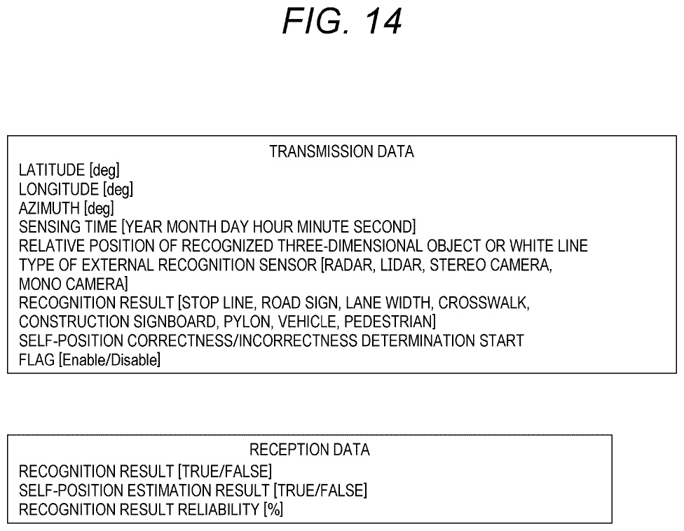

Here, data transmitted and received between the vehicle mounted device 1 and the cloud server 2 is illustrated in FIG. 14. As illustrated herein, the transmission data of the present embodiment is added with a self-position correctness/incorrectness determination start flag as compared with the transmission data of FIG. 3. Further, in the reception data of the present embodiment, correctness or incorrectness of the self-position estimation result is added as compared with the reception data of FIG. 3.

As a result, in the cloud server 2 of the present embodiment, it is possible to determine whether the self-position P is correct or incorrect in addition to whether the recognition result R of the vehicle mounted device 1 is correct or incorrect. Therefore, when the estimation of the self-position P is wrong, the vehicle mounted device 1 that has received the determination result of the cloud server 2 can stop the vehicle control or correct the self-position P.

The present invention is not limited to the embodiments described above, but includes various modifications. For example, the above embodiments have been described in detail for easy understanding of the present invention, and the present invention is not necessarily limited to those having all the configurations described. Each of the above configurations, functions, processing units, processing means, and the like may be partially or entirely achieved by hardware by, for example, designing by an integrated circuit. The configurations and the functions may be realized in software such that a processor analyzes and performs a program which realizes each function. The information such as the programs, tables, files, and the like for realizing the respective functions can be placed in a recording medium such as a memory, a hard disk, or a Solid State Drive (SSD), or a recording medium such as an IC card, an SD card, a DVD, or the like.

### REFERENCE SIGNS LIST

100 external recognition abnormality determination system
1 vehicle mounted device
11 navigation map
12 self-position estimation unit
13 external recognition sensor
14 recognition unit
15 data transmission unit
16 data reception unit
17 control possibility determination unit
18 driving control unit 18
19 recognition result request determination unit
2 cloud server
21 data accumulation unit
21a high precision map
22 recognition result determination unit
23 temporary storage unit
24 update determination unit
25 data reception unit
26 data transmission unit
27 position information determination unit
28 recognition result request unit
V vehicle
R recognition result
P self-position
J determination result

1. An external recognition abnormality determination system that determines abnormality of an operation of an external recognition sensor of a vehicle, wherein
the vehicle transmits, to a cloud server, type information and a recognition result of the external recognition sensor, and a self-position estimation result that is an estimation result of a self-position of the vehicle,
the cloud server accumulates cloud data in which type information and recognition results of the external recognition sensors which are received from a plurality of vehicles and the self-position estimation result are associated with map information, and updates the cloud data, and
the cloud server determines an abnormality in operation of the external recognition sensor based on the recognition result and the cloud data.

2. The external recognition abnormality determination system according to claim 1, wherein
the cloud server selects a point where an abnormality in operation of the external recognition sensor is determined based on the cloud data.

3. The external recognition abnormality determination system according to claim 1, wherein
the cloud server determines an abnormality of the self-position estimation result based on the recognition result at any two points of the vehicle or information on a plurality of targets included in the recognition result and the cloud data.

4. A vehicle mounted device that cooperates with a cloud server, the vehicle mounted device comprising:
a self-position estimation unit that estimates a self-position of a vehicle;
an external recognition sensor that detects an inside of a predetermined sensing range;
a recognition unit that recognizes a target based on a detection result of the external recognition sensor;
a data transmission unit that transmits, to the cloud server, a self-position that is an output of the self-position estimation unit and a recognition result that is an output of the recognition unit;
a data reception unit that receives a determination result indicating that the cloud server has made an abnormality determination with respect to the recognition result; and
a control possibility determination unit that determines possibility of driving assistance control or automated driving control according to the determination result.

5. The vehicle mounted device according to claim 4, wherein
the data transmission unit transmits the recognition result to the cloud server at a position designated by the cloud server.

6. The vehicle mounted device according to claim 4, wherein
the data transmission unit transmits a self-position correctness/incorrectness determination start flag to the cloud server, and
the data reception unit receives whether the self-position is correct or incorrect from the cloud server.

7. A method for determining abnormalities in external recognition of performing abnormality determination of a vehicle mounted external recognition sensor by a cloud server, the method comprising:
a first step of estimating a self-position of a vehicle;
a second step of detecting an inside of a predetermined sensing range by the external recognition sensor;
a third step of recognizing a target based on a detection result of the external recognition sensor;
a fourth step of transmitting a self-position that is an output of the first step and a recognition result that is an output of the third step to the cloud server;
a fifth step of performing abnormality determination on the recognition result by comparing the recognition result with cloud data accumulated in the cloud server;
a sixth step of transmitting a determination result of the fifth step from the cloud server to the vehicle; and
a seventh step of determining whether to perform a driving assistance control or an automated driving control according to the determination result.
